(19) United States
(12) Patent Application Publication
(10) Pub. No.: US 2011/0300570 A1
(43) Pub. Date: Dec. 8, 2011

(54) METHOD AND SYSTEM FOR GENERATING SPATIALLY AND TEMPORALLY CONTROLLABLE CONCENTRATION GRADIENTS

(75) Inventors: Ali Khademhosseini, Cambridge, MA (US); Yanan Du, Cambridge, MA (US); Matthew Hancock, Cambridge, MA (US)

(73) Assignee: THE BRIGHAM AND WOMEN'S HOSPITAL, INC., Boston, MA (US)

(21) Appl. No.: 13/129,190

(22) PCT Filed: Nov. 16, 2009
(86) PCT No.: PCT/US09/64555

§ 371 Date: Aug. 4, 2011

Related U.S. Application Data
(60) Provisional application No. 61/114,539, filed on Nov. 14, 2008.

(51) Int. Cl. G01N 1/00; C12Q 1/02; B01L 3/00; C12M 1/34

(52) U.S. Cl. 435/29; 435/288.7; 436/180; 422/502

(57) ABSTRACT

The ability to rapidly generate concentration gradients of diffusible molecules has important applications in many chemical and biological studies. The present invention is directed to methods and systems for generating spatially and temporally controllable concentration gradients of molecules (i.e. proteins or toxins) in a portable microfluidic device. The formation of the concentration gradients can be initiated by an induced forward flow and further optimized during an induced backward flow. The forward and backward flows can be either passively induced and/or actively pumped. The centimeter-length gradients along the microfluidic channel can be spatially and temporally controlled by the backward flow. The gradient profile was stabilized by stopping the flow. In one example, a stabilized concentration gradient of a cardiac toxin, Alpha-cypermethrin, generated according to the invention was used to test the response of HL-1 cardiac cells in the microfluidic device, which correlated with toxicity data obtained from multi-well plates. The invention can be useful for bio-logical and chemical processes that require rapid generation of concentration gradients in a portable microfluidic device.

### CROSS-REFERENCE TO RELATED APPLICATIONS

This application claims any and all benefits as provided by law of U.S. Provisional Application No. 61/114,539 filed Nov. 14, 2008, the entire contents of which are hereby incorporated by reference in its entirety.

### STATEMENT REGARDING FEDERALLY SPONSORED RESEARCH

This invention was made with government support under Grant Nos. 103577, HL092836, DE019024, and EB007249 awarded by the National Institutes of Health. The US Government has certain rights in this invention.

### REFERENCE TO MICROFICHE APPENDIX

Not Applicable

### BACKGROUND

1. Technical Field of the Invention

The present invention is directed to methods and systems for rapidly generating concentration gradients of diffusible molecules, polymers, beads and cells. Further, the invention is directed to methods and systems for rapidly generating spatially and temporally controllable concentration gradients of these gradient materials in a portable microfluidic device.

2. Description of the Prior Art

Natural materials exhibit anisotropy with variations in soluble factors, cell distribution, and matrix properties. The ability to recreate the heterogeneity of the natural materials is a major challenge for investigating cell-material interactions and for developing biomimetic materials.

Anisotropic materials are highly important for many natural and engineered systems. Examples of anisotropic materials in nature include marbles, tree trunks and squid beaks. Examples of engineered anisotropic materials include the birefringent crystals of prisms, the metal wood head of golf clubs and the aluminum alloys used in aircraft and rockets. Spatial anisotropy in materials is especially prominent in cellular microenvironments in vivo where heterogeneous distributions of cells and molecules exist within spatially varying extracellular matrices (ECM). Molecular concentration gradients play an important role in biological phenomena such as chemotaxis, morphogenesis and wound healing. Meanwhile, the graded variations of ECM and cell concentration at the tissue interface (e.g. bone-cartilage interface, dentino-enamel junctions) are nature's solution for connecting mechanically mismatched tissues. Creating chemical and material gradients to mimic the heterogeneity of cellular environments is important for investigating cell-matrix interaction and for developing biomimetic materials for tissue engineering.

Concentration gradients of diffusible molecules (chemical compounds or biomolecules) play an important role in many chemical processes (e.g. crystal growth) as well as biological phenomena (e.g., chemotaxis, morphogenesis and wound healing). A variety of approaches have been developed for generating gradients of diffusible molecules driven either purely by diffusion or by a balance of convection and diffusion. Most of the existing approaches for gradient generation are diffusion-driven, which can be generally categorized into: (1) forming gradients perpendicular to parallel laminar flows of varying concentrations and (2) forming gradients along a channel by free-diffusion between a source and a sink. The first method is advantageous for producing stable complex gradients, but the experiments are not compatible with non-adherent and weakly adherent cells and the shear/drag force generated by the flow may alter the intercellular signaling pathways. Moreover, to generate the laminar flows, pumping systems with external connections (i.e. tubing and valves) are often used, which limit the portability and ease of use of the device 16. To maintain a continuous flow, relatively large volumes of fluid containing the materials of interests are consumed, which constrain their applications for precious materials (i.e. growth factors, drugs).

The second approach normally requires larger gradient generation times and the gradient produced is unstable and hard to maintain over long time periods. Gradients have also been formed parallel to the direction of flow. Goulpeau et al. built up longitudinal concentration gradients along their ancrochannel by using transient dispersion along the flow. Kang et al. developed a device that generated concentration gradients parallel to the direction of flow by using a convective-diffusive balance in a counter-flow configuration. Although these approaches could be used to rapidly generate concentration gradients in less than one minute, they still required external components i.e. hydrostatic pumps or valves to introduce and control the flows within the channels.

The ability to build pumpless fluidic devices that generate controllable gradients while maintaining the portability and scalability of microfluidic systems is of significant benefit for field testing and high-throughput studies. Furthermore, the ability to generate longer gradients cart be used to test the effects of molecular dose responses on cell behaviors. One approach to eliminate the use of external pumps is by using a passive-pump technology, which was first developed by G. M. Walker et al. as a semi-autonomous method for pumping fluid. Passive-pump technology only requires a device capable of producing small drops of liquid, such as a pipette. The surface tension difference between the larger drop of solution at the outlet and smaller drop of solution at the inlet was used to pump the small drop of liquid through the micro-channel, which has been shown to be a powerful high-throughput microfluidic tool for cell culturing. Evaporation has also been used as driving force in pump-less' microfluidic devices. Evaporation is a well-known issue when handling small liquid volumes, especially in microfluidic devices. While the loss of volume due to evaporation may cause unwanted effects such as the change of concentrations or osmolarity of the fluid solution; evaporation in microfluidic devices has proven to be a useful tool in several applications, including generating slow, steady flows in microchannels used for chromatography, DNA analysis devices, and sample concentration.

Various methods exist to generate molecular and material gradients. Diffusion-based approaches for gradient generation are limited to diffusible molecules and require long times to create millimeter length gradients, since the timescale for pure diffusion scales as length squared. Dispersion-based approaches, which combine primary stretching by flow shear and secondary spreading by diffusion, have been used to generate centimeter long molecular gradients in seconds to minutes. However, so far no generic platform employing dispersion to generate stable material gradients of single or multiple components over long distances have been developed.

### SUMMARY

The present invention is directed methods and systems for rapidly generating concentration gradients of diffusible materials (including chemical compounds and biologic molecules), polymers, beads, particles and cells in the channel of a microfluidic device. In accordance with the invention, alternating flows are induced in the channel to produce multi-centimeter long concentration gradients. Methods and systems according to the invention use alternating flows and hydrodynamic stretching to rapidly generate long gradients of these gradient materials and long cross-gradients of two species of gradient materials in a simple microchannel. In accordance with the invention, the length of the concentration gradient can be predetermined for wide range of material properties. For example, a polyethylene-glycol) hydrogel gradient, a porous collagen gradient and a composite material with a hyaluronic acid/gelatin cross-gradient can be generated with continuous variations in material properties and in their ability to regulate cellular response. The present invention can be useful for creating anisotropic biomimetic materials and high-throughput platforms for investigating cell-microenvironment interaction.

In one embodiment of the invention, methods and systems according to this embodiment utilize a forward flow induced by the passive-pumping and a reversed flow induced by evaporation to rapidly establish centimeter-length concentration gradients of molecules along the channel of a simple and portable microfluidic device. Passive-pumping is used to generate a forward flow from the inlet to the outlet of the channel, which introduced the gradient material (molecules of interest) into the microfluidic device in a rapid and simple manner and initiated a concentration gradient profile of the molecules due to the parabolic shape of the front flow. An evaporation-induced backward flow from the outlet to the inlet of the channel followed the forward flow resulting in the formation of dynamic concentration gradients of the molecule. The gradient profile can be stabilized by stopping the flow. The centimeter-length concentration gradients were in parallel with the flow direction along the microfluidic channel and can be spatially and temporally controlled.

In an alternative embodiment of the invention, methods and systems according to this embodiment utilize a pumping mechanism that produce fast alternating flows, which continually lengthen the gradient. In addition, the methods and systems according to this embodiment utilize the pumping mechanism to produce fast alternating flows of a second gradient material to generate a cross gradient.

In accordance with an alternative embodiment, a non-viscous solution, such as a buffered solution is input into the channel of the microfluidic device and the gradient material is pumped into in one or more cycles of alternating forward and backward flows. Each cycle can be defined to include injecting into the inlet a predefined volume of gradient material at a predefined flow rate, imparting a predefined forward flow velocity on the gradient material, waiting a predefined period of time to allow for diffusion and withdrawing a predefined volume of gradient material from the inlet at a predefined flow rate, imparting a predefined backward flow velocity on the gradient material. Optionally, a predefined waiting period to allow for diffusion between cycles can be provided. In accordance with the invention, the length of the gradient in the channel can determined as function of the flow velocity and the amount of time that the gradient material flows.

The present invention provides methods and systems for simple and rapid generation of relatively long concentration gradients in portable microfluidic devices. The present invention can provide that: 1) the concentration gradient is generated by dispersion, the combined effect of convection and molecular diffusion, and flow reversal, which changes the direction of the parabolic flow; 2) due to the convection-driven nature, the process of gradient generation was rapid (within several minutes), highly dynamic (throughout the backward flow stage) and spatially/temporally controllable (by controlling the evaporation-induced backflow); 3) the gradient can be formed by consuming low amounts of the gradient material (particles, cells, or molecules, etc.) of interest; 4) centimeter-length concentration gradients can be generated parallel to the flow direction along the channel; and 5) the process is simple and highly reproducible in a portable microfluidic device, requiring only a pipette for implementation.

The present invention is directed to a versatile platform for generating centimeter scale gradients of a broad range of gradient materials, from molecular to micron scale, in seconds to minutes. Particle and cell concentration gradients can be produced by high-speed alternating fluidic shear in a simple microfluidic channel. For diffusible gradient materials, flow sequences according to the invention can be used to generate long and laterally uniform gradients, including 2-3 cm gradients of fluorescent dyes. The same flow sequences can also be used to create gradients of hydrogels and cross gradients composite materials (such as, HA-gelatin, which possessed a gradient in cell-attachment). In accordance with the invention, gradient generation can be controlled using a formula for estimating gradient growth which is useful over a wide range of Péclet numbers and channel geometries.

It is an object of the invention to generate a concentration gradient of a gradient material over a predefined length of a microfluidic channel.

It is another object of the invention to rapidly generate a concentration gradient of a gradient material over a predefined length of a microfluidic channel.

It is an object of the invention to rapidly generate a stable concentration gradient of a gradient material over a predefined length of a microfluidic channel.

It is an object of the invention to rapidly generate a stable concentration gradient of a gradient material over a predefined length of a microfluidic channel, where the gradient material cart include biomolecules, cells, particles, polymers, and beads.

It is an object of the invention to generate a stable cross-concentration gradient of two gradient materials over a predefined length of a microfluidic channel.

It is an object of the invention to generate a concentration gradient of a gradient material by causing a sequence of forward flows and backward flows in a microfluidic channel.

These and other capabilities of the invention, along with the invention itself, will be more fully understood after a review of the following figures, detailed description, and claims.

### BRIEF DESCRIPTION OF THE FIGURES

FIG. 1 is a diagrammatic view of a microfluidic device according to the invention.

FIG. 2 is a flow chart of a process for generating concentration gradients according to the invention.

FIGS. 3A-3D show a diagrammatic view of a process for generating concentration gradients according to the invention.

FIGS. 4A-4D show experimental and simulated results of dynamic gradient generation according to the invention.

FIGS. 5A-5B show diagrammatic views of gradient generation by dispersion according to the invention.

FIG. 6A shows diagrammatic views of the evolution of the concentration gradient over time due to molecular diffusion, according to the invention.

FIG. 6B shows simulated results of the evolution of the concentration gradient over time due to molecular diffusion, according to the invention.

FIG. 7 is a diagrammatic view of a microfluidic device according to the invention.

FIG. 8 is a flow chart of a process for generating concentration gradients according to the invention.

FIG. 9 is a flow chart of a process for generating a cross-gradient according to the invention.

FIGS. 10A-10D show diagrammatic views of modes of gradient generation in channel flow according to the invention.

FIGS. 11A-11C show diagrammatic views of the generation of long range molecular gradients according to the invention.

FIGS. 12A-12E show diagrammatic views of the generation of long range particle, cellular and material gradients according to the invention.

FIGS. 13A-13D show diagrammatic view of a cross gradient generated according to the invention.

### DETAILED DESCRIPTION OF PREFERRED EMBODIMENTS

The present invention is directed methods and systems for rapidly generating concentration gradients and cross-gradients of gradient materials (e.g., diffusible molecules, chemical compounds, biologic molecules, polymers, beads, particles, and cells) in the channel of a microfluidic device. In accordance with the invention, alternating flows are introduced in the channel of the microfluidic device to produce multi-centimeter long concentration gradients.

### Passive-Pumping

Methods and systems according to one embodiment of the invention utilize a forward flow induced by the passive-pumping and a reversed flow induced by evaporation to rapidly establish centimeter-length concentration gradients of molecules along the channel of a simple and portable microfluidic device. Passive-pumping is used to generate a forward flow from the inlet to the outlet of the channel, which introduced the molecules of interest (with volume less than 10 μL) into the microfluidic device in a rapid and simple manner and initiated a concentration gradient profile of the molecules due to the parabolic shape of the front flow. Passive-pumping includes applying one or more droplets to the inlet port of the microfluidic channel. An evaporation-induced backward flow from the outlet to the inlet of the channel followed the forward flow resulting in the formation of dynamic concentration gradients of the molecule. The gradient profile can be stabilized by stopping the flow. The centimeter-length concentration gradients were in parallel with the flow direction along the microfluidic channel and can be spatially and temporally controlled.

In accordance with the invention, one methodology used to generate the concentration gradient relies on the flow properties and the combined effect of convection and diffusion of the gradient materials into the base solution in the microfluidic channel. Throughout the channel, the flow is essentially fully-developed laminar Poiseuille flow in a rectangular channel, a textbook example where the Navier-Stokes equations admit an exact solution. The Peclet numbers for the forward and backward flows are approximately 1000 and 10, respectively. In the axial direction, the chemical transport is mainly due to convection; since the flow is essentially axial, the transport in the transverse direction is mainly due to molecular diffusion. This type of chemical spreading, involving both axial convection and transverse molecular diffusion, is called Taylor dispersion. Theoretical descriptions of dispersion in microchannels are well developed. Much of the existing theory for dispersion assumes steady flow. While the flows due to the passive-pump and evaporation stages are approximately steady, the transition between the two (flow reversal) is not but we can solve numerically to determine the flow and chemical concentration parameters.

Computational simulations of the gradient generation and stabilization agree well with the experimental data, which show that the concentration gradients are mainly generated and controlled by a combined effect of convection (forward and backward flow) and molecular diffusion. In one example, the portable microfluidic device according to the invention was used to rapidly generate a stabilized concentration gradient of a cardiac toxin used for conducting a cytotoxicity test. The stabilized concentration gradient of a cardiac toxin was used to test the toxicity response of HL-1 cardiac cells seeded within the channel. The present invention provides for ease of use, portability, low consumption and scalability and can be useful for various biological and chemical processes where rapid generation of long-range concentration gradients can be used.

The microfluidic device can be fabricated by using standard soft-lithography methods. Photomasks with channel patterns were designed using AutoCAD and printed on transparencies with 20,000 dpi resolution (CAD/Art Services, Inc., Bandon, Oreg.). Master molds patterned with 100 μm thick resist were made by patterning a negative photoresist (SU-8 2050, Microchem, MA) on a silicon wafer. PDMS molds were fabricated by curing prepolymer (Sylgard 184, Essex Chemical, Midland, Mich.) on silicon masters patterned with SU-8 photoresist. Briefly, PDMS molds were generated by mixing silicone elastomer and curing agent (10:1 ratio). The PDMS prepolymer was poured on the silicon master that was patterned with photoresist and cured at 70° C. for 2 h. PDMS molds were then peeled off from the silicon wafer. The inlet and outlet of the microchannel were created by a sharp punch (hole radius: 0.4 mm) for medium perfusion and cell seeding. The microfluidic device consisted of a top PDMS fluidic channel and a bottom glass slide. The top fluidic channel was 100 μm (height)×50 mm (length)×1.6 mm (width), which was bonded to the bottom glass slide after treatment by oxygen plasma (Hayrick Scientific, Pleasantville, N.Y.).

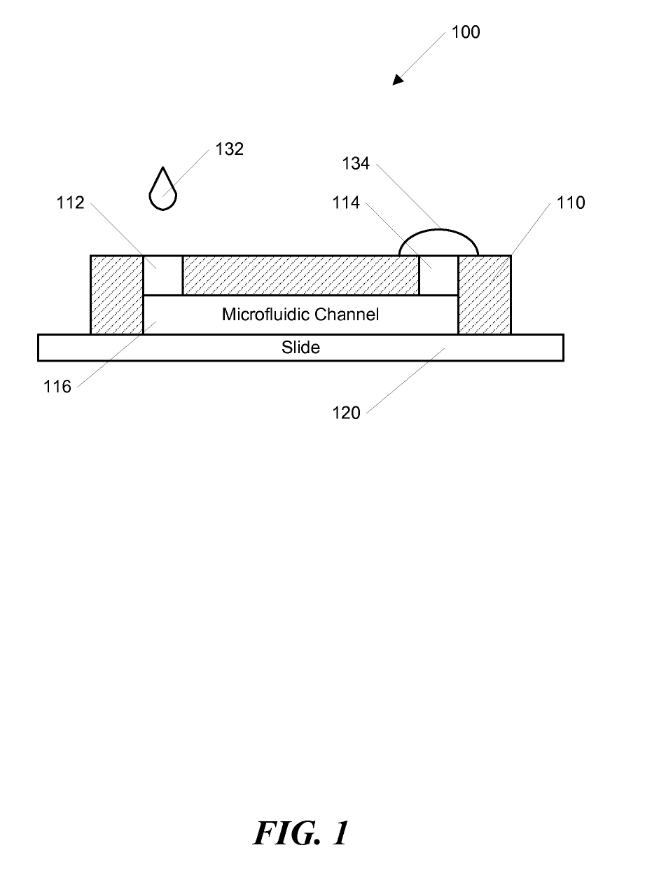

FIG. 1 shows a diagram of a microfluidic device 100 according to an embodiment of the invention. The microfluidic device 100 includes a top portion 110 into which the microfluidic channel 116 is formed. The top portion 110 can be bonded to a bottom portion 120. The microfluidic device 100 also includes an inlet port 112 connected to one end of the microfluidic channel 116 and an outlet port 114 connected to the other end of the microfluidic channel 116. In preparation of the concentration gradient, the channel can be filled with a buffered solution (or culture medium) and a large drop 134 of the buffered solution can be placed on the outlet port 114. After the large drop 134 of buffered solution is placed on the outlet port 114, one or more smaller drops or droplets 132 of the gradient material can be placed on the inlet port 112 to begin the passive-pumping process.

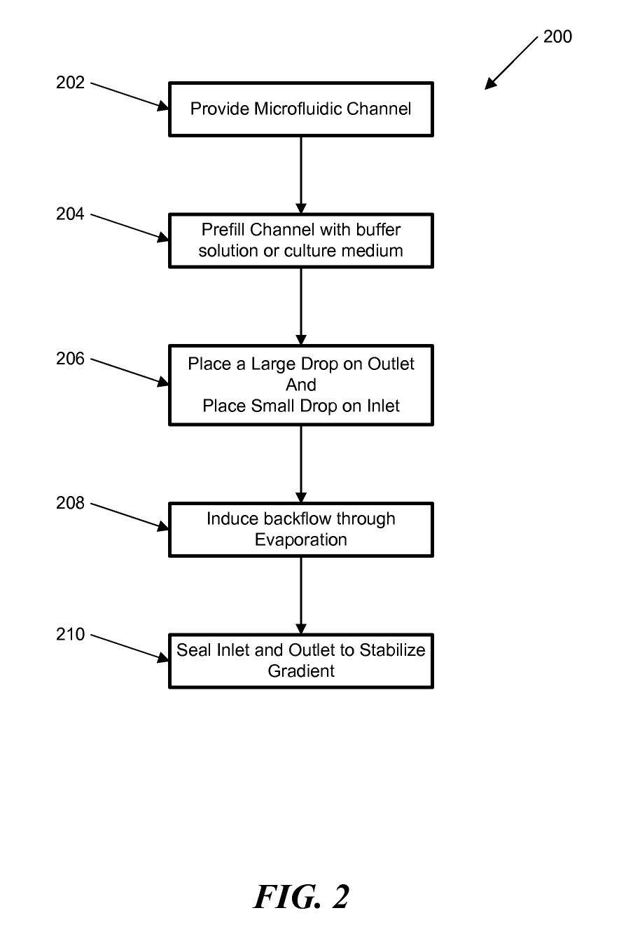

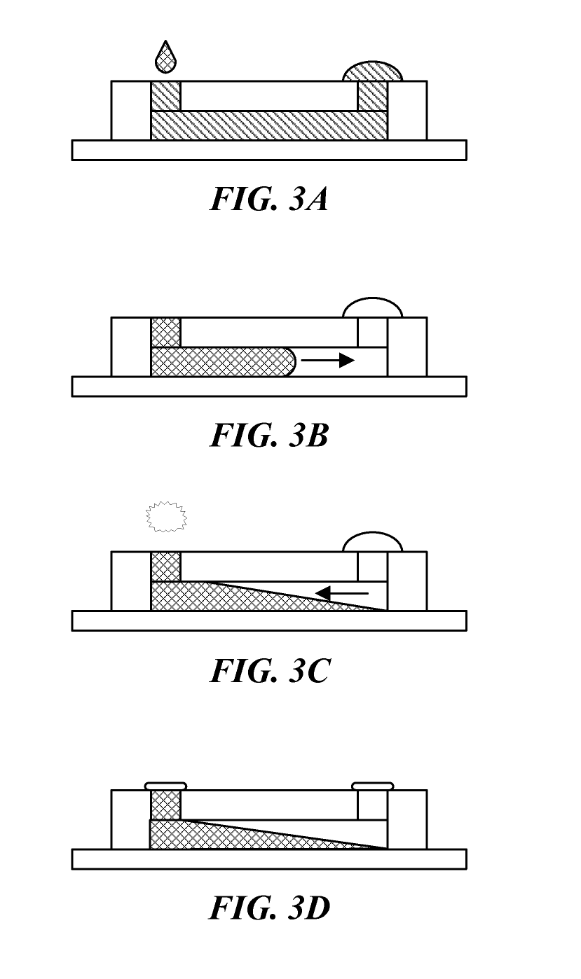

FIG. 2 shows a flow chart of the process of generating the concentration gradient in the microfluidic channel 116 according to one embodiment of the invention. FIGS. 3A-3D show a diagrammatic representation of process of generating the concentration gradient in the microfluidic channel 116 according to one embodiment of the invention. In accordance with the invention, the microfluidic channel 116, having an inlet port 112 and an outlet port 114, in which the concentration gradient is to be created, is provided at 202. The microfluidic channel 116 can be part of a microfluidic device 100 such as shown in FIG. 1. The microfluidic channel 116 is prefilled with a non-viscous solution, such as a buffer solution or culture medium, at 204. At 206 and as shown in FIG. 3A, a large drop 134 of the non-viscous solution is placed on the outlet port 114 and one or more small drops 132 are placed on the inlet port 112 to initiate the passive-pumping process and causing the gradient material to flow forward in the channel 116, from the inlet port to the outlet port as shown in FIG. 3B. After the last of the one or more small drops 132 are introduced to the inlet port, the gradient material at the inlet port was allowed to evaporate to cause the gradient material to flow backward, from the outlet port to the inlet port at 208 and as shown in FIG. 3C. After a predetermined period of time, the desired length of the concentration gradient is generated and the inlet port 112 and the outlet port 114 are sealed to stabilize the gradient at 210 and as shown in FIG. 3D.

The size of the large drop 134 can determined as a function of the desired passive-pumping action to induce the desired flow, given the materials used. For example, the large drop 134 cart range from 100 μL to 500 μL. Similarly, the small drop 132 can be determined as a function of the desired flow. For example, the small drop can be a small droplet and can range from 1 μL to 5 μL. Evaporation at the inlet port can be naturally induced, such as the result of ambient environmental conditions or can be actively induced by subjecting the environment adjacent to the inlet port to decreasing pressure or increasing temperature. The length of time that the evaporation-driven backflow is allowed to continue can be determined by the desired length of the concentration gradient. In one example, the time ranged from 10 minutes to 50 minutes and the time of the backflow can be longer than 50 minutes depending on the characteristics of the system and the desired length of the concentration gradient.

Depending on the intended use of the concentration gradient, the microfluidic device can be cooled, frozen, freeze-dried, exposed to UV energy or otherwise processed further to cause the solution in which the gradient was generated to solidify allowing the top portion of the microfluidic device to be removed so that the concentration gradient can be exposed and/or harvested.

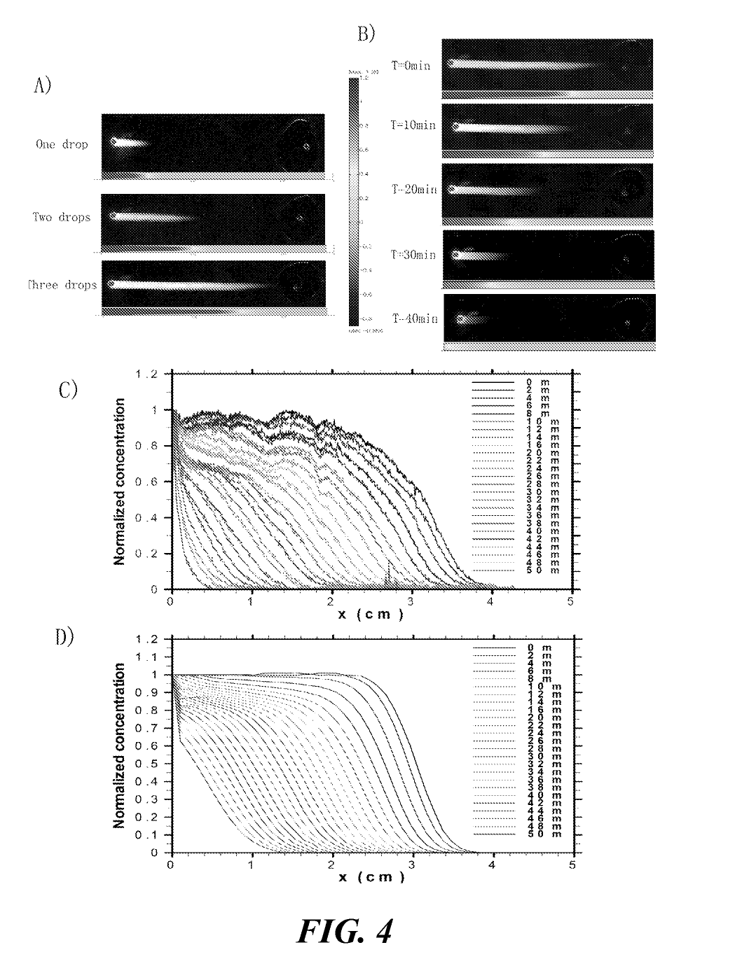

FIGS. 4A-4D show the experimental and simulation results of dynamic gradient generation in the microfluidic channel. FIG. 4A shows fluorescence images of the forward flow of a solution containing FITC-Dextran into the microfluidic channels produced by passive-pumping. The corresponding simulation results obtained by the finite element method are positioned directly below each experimental fluorescence images. The vertical color scale denotes fluorescence intensity. FIG. 4B shows fluorescence images of the generation of a dynamic gradient of FITC-Dextran produced by evaporation-driven backward flow. The corresponding simulation results obtained by finite element method are positioned below the experimental images. FIG. 4C shows experimental results and FIG. 4D shows simulation results of the normalized fluorescence signal of FITC-Dextran along the channel at different times during the backward flow.

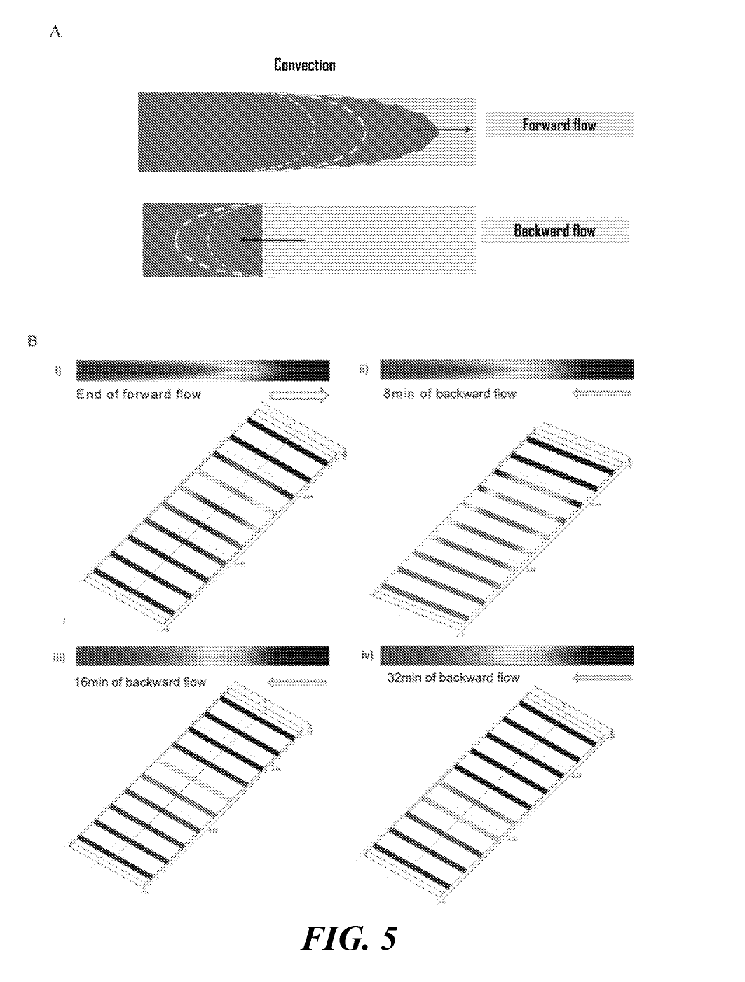

FIGS. 5A-5B show the gradient generation by dispersion (convection and diffusion). FIG. 5A shows the effect of flow reversal on concentration gradient. FIG. 5B shows the simulated results that verify the effects of dispersion on the formation and dynamic change of the concentration gradient, including top-down and cross-sectional views of the simulation results of the concentration profiles. FIG. 5Bi shows the concentration profile at the end of the forward flow. FIG. 5Bii shows the concentration profile after 8 min of backward flow. FIG. 5Biii shows the concentration profile after 16 min of backward flow. FIG. 5Biv shows the concentration profile after 32 min of backward flow.

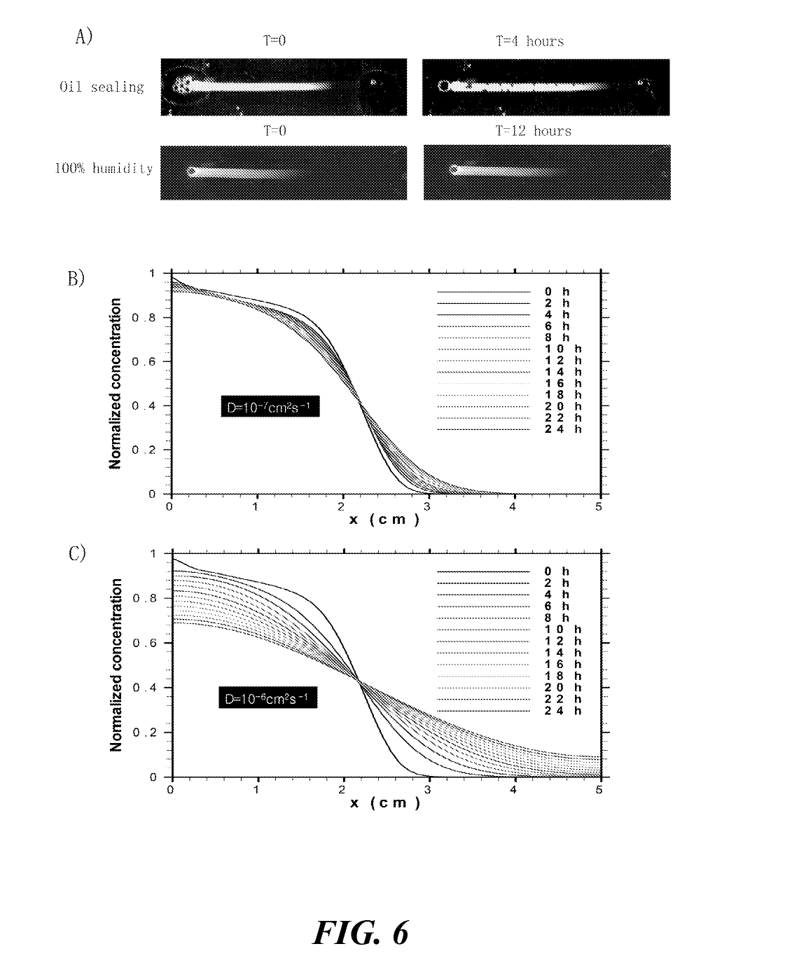

FIGS. 6A-6D show the evolution of the concentration gradient profile due to molecular diffusion after backward flow was stopped. FIG. 6A shows FITC-Dextran in the microfluidic channel for 4 h with flow stopped by oil sealing (top) and for 12 h with flow stopped by maintaining a 100% humidity environment (bottom). FIGS. 6B and 6C show the simulation results of the dynamic concentration gradient driven by molecular diffusion over one day. FIG. 6B shows the result for molecules with diffusivity of 10⁻⁷ cm²s⁻¹ and FIG. 6C shows the results for molecules with diffusivity of 10⁻⁶ cm²s⁻¹.

### Example 1

In one example according to the invention, the channel was initially filled with Dulbecco's Phosphate Buffered Saline (DPBS, Gibco, Carlsbad, Calif.). A 200 μL drop of DPBS was pipetted onto the outlet opening and a 2 μL drop of DPBS containing the molecule of interest was dropped onto the inlet opening and subsequently entered the channel automatically. After the small drop entered the channel completely, a second drop containing 2 μL was pipetted onto the inlet to continue the forward flow. When the inlet was not refilled, the forward flow would stop and a backflow occurred due to evaporation at the room humidity (˜65%). To visualize the dynamic process of the concentration gradient generation, fluorescein isothiocyanate-dextran (FITC-Dextran, molecular weight (MW): 10 kD) was used as the model molecule, and the fluorescence image series was captured using a Kodak Gel Logic 100 Imaging System, shown in FIGS. 4-6. The average fluorescence intensity along the whole channel was quantified by ImageJ software. To stabilize the concentration gradient, the evaporation-driven flow was stopped by either sealing the inlet port and optionally, the outlet port with a drop of mineral oil or putting the microfluidic device into an enclosure with 100% humidity.

Computational fluid dynamics was used to simulate the dynamic process of concentration gradient generation using the finite element method (COMSOL Multiphysics v3.2, Burlington, Mass.). Unstructured mesh generation method was performed and 5420 elements were used for constructing the 3D mesh domain. The concentration gradient generation driven by the passive pump and evaporation fluid model was based on the following three equations, including the 3D incompressible Navier-Stokes equations (i.e. the momentum and continuity equations):

$$\begin{matrix}ρ ( \frac{\partial u}{\partial t} + ( u \cdot ∇ ) u ) = - ∇ p + μ {∇}^{2} u & ( 1 ) \\ ∇ \cdot u = 0 & ( 2 )\end{matrix}$$

and the convection-diffusion transport equation:

$$\frac{\partial C}{\partial t } + ( u \cdot ∇ ) C = D {∇}^{2} C \qquad ( 3 )$$

where ρ, u, and p are the density, flow velocity and pressure of the liquid, and C and D are the concentration and diffusivity of the molecules in the liquid. At each time step, the flow u is first found independently of the concentration, which is then found using the computed flow. The boundary conditions are as follows. At the inlet, the flow velocity was set to 0.08 cm/s for the forward flow and 10.1 μm/s for the backward flow. These values agree with the average flow rates produced by the passive pump and by evaporation, experimentally observed and analytically calculated (see Appendix A). At the outlet we imposed zero normal stress, and at the channel walls we imposed the no-slip conditions (u=0). For the convection-diffusion equation, constant concentration was set at the channel inlet and zero concentration at the channel outlet. No-flux conditions were imposed at all, channel walls

$$( \frac{\partial C}{\partial n} = 0 ) .$$

Table 1 in Appendix A summarizes the input parameters used for the numerical simulations. The channel geometry was set as 5 cm×1600 μm×100 μm and FITC-Dextran was used as the model dye molecules. To quantify the simulation results with time, the concentrations were extracted from the centerline along the channel and normalized with the maximum concentration at the inlet of the channel.

### Cytotoxicity Testing

HL-1 cells (Cardiac muscle cell line) were cultured with medium containing 87% Claycomb Medium, 10% Fetal Bovine Serum (FBS), 1% Penicillin/Streptomycin, 1% Norepinephrine, and 1% L-Glutamine at 37° C. in a humidified 5% CO2/95% air incubator. To enhance the cell adhesion, the bottom glass slide was coated with a mixture of extracellular matrix (0.02% gelatin (w/w) and 5 μg/mL fibronectin) after the top channel was bonded to the bottom glass slide. To seed the cells into the microfluidic device, the cells were trypsinized and seeded through the outlet port using dynamic seeding at a cell density of 2×106 cells mL-1 that allowed uniform cell distribution. Cells were cultured for 2 h to ensure attachment. The medium was then changed and 3 drops of 2 μL medium containing 20 mM Alpha-cypermethrin were introduced by passive pumping and a concentration gradient was established by leaving the microfluidic device in the hood for 5 min to allow for evaporation-induced backflow. The microfluidic device was then transferred to a humidified incubator where the concentration gradient of the toxin was stabilized and the cells were treated for 4 h. Cell morphology and viability was characterized by peeling off the top channel and incubating the cells with live/dead dyes (2 μL Calcein AM and 0.5 μL Ethidium homodimer-1, Molecular Probes, California) in 1 mL DPBS for 10 min. ImageJ was used to quantify the fluorescence images of live-dead staining of the cells. At least three images were used for quantification of the cell viability.

### Example 2

In another example, a stable concentration gradient was produced using the process shown in FIG. 3. As described above, FIG. 3 shows a schematic diagram of the gradient generation and stabilization process: A) Microfluidic channel was first filled with DPBS; a large drop of DPBS was placed on the outlet opening and a small drop of the gradient material containing diffusible molecules was pipetted on the inlet opening, B) solution was introduced into the channel automatically by the passive-pump-induced forward-flow; C) a concentration gradient of molecules was generated during the evaporation-based backward flow; D) the gradient profile could be stabilized by stopping the evaporation, either by sealing the inlet with mineral oil or by maintaining the microfluidic device at 100% humidity.

In this example, the microfluidic channel was initially filled with DPBS, and a 200 μL drop of DPBS was pipetted onto the outlet. A small drop of 2 μL DPBS containing FITC-Dextran was then dropped onto the inlet (FIG. 3A) and entered the channel automatically due to the differential surface tensions between the drops (FIG. 3B). After the small drop entered the channel completely, a second drop was pipetted onto the inlet to continue the forward flow. In this example, three drops were sufficient for the fluid to reach the desired distance in the channel, in this example, the outlet end of the 5 cm-long channel. The forward flow rate was ˜1 mm/s as measured experimentally and calculated analytically. Therefore, approximately one minute was required to introduce three drops of solution containing the fluorescent dye into the channel via the forward flow as shown in FIG. 4A. Following the forward flow, a backward flow was induced by the evaporation of the solution from the inlet. The concentration gradient of the fluorescent dye formed along the channel, which was parallel to the backward flow and moving backward toward the inlet, a shown in FIG. 3C and FIG. 4b. The backward flow rate was 10.1 μm/s as measured experimentally and calculated analytically, which was significantly slower than the forward flow rate. The evolution of the centimeter-long concentration gradient that formed along the channel during the 50 min backward flow was quantified by measuring the fluorescent intensity along the channel and is shown in FIG. 4C, which was assumed to be proportional to the concentration of the fluorescent molecules. During the backward flow, the fluorescent dye and the concentration gradient moved backward toward the inlet, and the gradient steepened.

The gradient is generated by dispersion, the combined effect of convection and molecular diffusion, and flow reversal, which changes the direction of the parabolic flow shown in FIG. 5A. Concentration distributions at different locations along the channel at different times are shown in FIG. 5B. The rapid forward flow generates a parabolic concentration profile as shown in FIG. 5B i. The backward flow then gradually flattens the parabolic profile and renders the concentration distribution laterally uniform as shown in FIG. 5B ii. A centimeter long concentration gradient with uniform cross-sectional distribution is formed after 16 min of backward flow for molecule with a diffusivity of 1.7×10-6 cm2/s (i.e. FITC-Dextran) as shown in FIG. 5B iii. As the backward flow continues, the concentration forms a slightly inverted parabolic profile. However, since the backward flow is significantly slower than the forward flow, the uniformity of the concentration distribution was not significantly affected, and a relatively uniform concentration gradient moved backward toward the inlet as shown in FIG. 5B iv.

The timescale for molecular diffusion across a distance L is L²/(π²D), where D is the molecular diffusivity. The timescales for vertical and horizontal mixing of FITC-Dextran across the 100 μm height and 1.6 mm width of the channel are therefore 6 seconds and 25 minutes, respectively. Thus, the chemical concentration is essentially uniform vertically across the microchannel, and it suffices to consider only its horizontal variation, as we have done. The timescale for molecular diffusion across the width of the channel is significantly greater than the duration of the forward flow and commensurate with the timescale of the backward flow. It is therefore instructive to consider the role of the backward flow on gradient generation. After a concentration profile was produced by the forward flow, we compared the concentration profiles obtained after a given duration of backward flow with those obtained instead from the same duration of pure diffusion. The results indicate that the main role of backward flow is to spatially place the gradient. Moreover, the backward flow slightly elongates the gradient by 1%-10%.

### Stabilization of the Concentration Gradient

To achieve the spatial and temporal control of the dynamic concentration gradients, a particular concentration gradient was stabilized using two methods to stop the flow. As shown in FIG. 3D and FIG. 6A, evaporation from the inlet can be prevented either by sealing with mineral oil or by placing the microfluidic device in an environment with 100% humidity (water bath or cell incubator). The oil sealing approach could stabilize a particular concentration gradient profile for up to 4 h before evaporation through the PDMS layer became noticeable (indicated by the small cavities in the fluorescence image in FIG. 6A, while a concentration gradient profile could be stabilized under 100% humidity for at least 12 h.

By preventing evaporation, the flow is stopped and spreading is due purely to (passive) molecular diffusion. The evolution of the concentration profile due only to molecular diffusion is shown over one day in FIGS. 6B and 6C. The flow was terminated by setting equal the pressures at both the inlet and outlet of the channel. The concentration gradient after 12 min of backward flow was used as the initial concentration profile. Simulations were run for two types of molecules with diffusion coefficients differing by an order of magnitude. The simulation results indicate that for large molecules with small diffusion coefficients (e.g. 10⁻⁷ cm²/s), little change in the concentration gradient occurs due to molecular diffusion after one day. For smaller molecules with larger diffusion coefficients (e.g. 10⁻⁶ cm²/s), the effect of molecular diffusion on the concentration gradient profile became evident after 6 h and approached equilibrium throughout the channel within one day.

Estimates can be made of the timescale over which the gradient is maintained, since exact analytical solutions are known for the diffusion equation for any initial concentration gradient. The exact solutions decay exponentially with rate constants approximately equal to π²D/L², where L is the length scale of the concentration gradient and D is the molecular diffusivity. The concentration gradient is maintained to within 10% of its initial state over a time interval of 0.1L²/(π²D). Centimeter-long concentration gradients of chemicals with molecular diffusivities of 10⁻⁷ cm²/s and 10⁻⁶ cm²/s remain within 10% of their initial states over time intervals of approximately 28 h and 2.8 h, respectively. These results indicate that stable concentration gradients can be maintained for molecules over a wide range of diffusion coefficients for several hours.

### Example 3

### Stabilized Concentration Gradient for Cytotoxicity Testing

In this example, the stabilized, spatially and temporally controllable concentration gradient technique is utilized for cytotoxicity testing. A cardiac muscle cell line (HL-1) is used to investigate the cytotoxicity of Alpha-cypermethrin, a cardiac toxin. Three drops of 2 μL medium containing 20 mM Alpha-cypermethrin were loaded consecutively into the micro-devices with HL-1 cells seeded along the channel. A concentration gradient of the toxin was established by evaporation when the micro device was left at ambient conditions for 5 min (5 min exposure does not cause severe damage to cell viability) and the gradient was stabilized when the micro device was transferred to the humidified incubator. HL-1 cells exposed to the toxin concentration gradient for 4 h exhibited distinguishable morphologies along the channel, with more severe effects observed in the regions containing higher concentrations of toxin. The drastic morphological change of HL-1 cells exposed to various concentrations of toxin was also observed when the cytotoxicity testing was conducted with HL-1 cells seeded in a 96-well plate. The cytotoxicity of the toxin gradient was further tested on the HL-1 cells by conducting a live-dead assay. A correlation of cell viability was found with the toxin concentration gradient along the channel. According to the correlation between cell viability and morphology changes with respect to Alpha-cypermethrin concentration obtained from the toxicity testing on HL-1 cells seeded in 96-well plates, the experimental conditions used in this example established a concentration gradient of the toxin from 12.5 mM to 0 mM along the 5 cm-length channel based on the assay conducted in this example.

According to the invention, the gradient generation process is highly reproducible at ambient conditions (i.e. 22 C, 30% relative humidity). Variations in temperature and humidity in the laboratory mainly affect the gradient generation process by slightly altering the backward flow rate induced by evaporation; their effects on the forward flow and the diffusion of the molecular are generally considered negligible.

The flow is essentially fully developed Poiseuille flow throughout the rectangular channel. Regions of adjustment to the fully developed flow exist at the ends of the channel. However, based on the Reynolds numbers (0.1 and 0.001) of the forward and backward flows, the extent of these adjustment regions is short: approximately the channel height. Thus, throughout the channel the flow is essentially fully-developed Poiseuille flow.

The concentration gradient profile according to the present invention can be easily altered and controlled by choosing the initial analyte concentration in the applied drops and by manipulating the timing of the forward and backward flow. The factors affecting the flow properties, such as the fluid viscosity, the pressure difference between the inlet and outlet, the rate of evaporation and the geometry of the microfluidic channel affect the gradient generation.

### Second Embodiment

Methods and systems according to an alternative embodiment of the invention utilize a pumping device, such a syringe pump, to drive fast alternating flows which continually lengthen the concentration gradient in the channel. This embodiment of the invention provides for rapidly generating multi-centimeter long concentration gradients along the channel in a simple and portable microfluidic device. Active pumping is provided to drive forward and backward flows in the channel. In addition, active pumping can be used to rapidly generate long cross gradients of two gradient materials in the channel of a simple and portable microfluidic device.

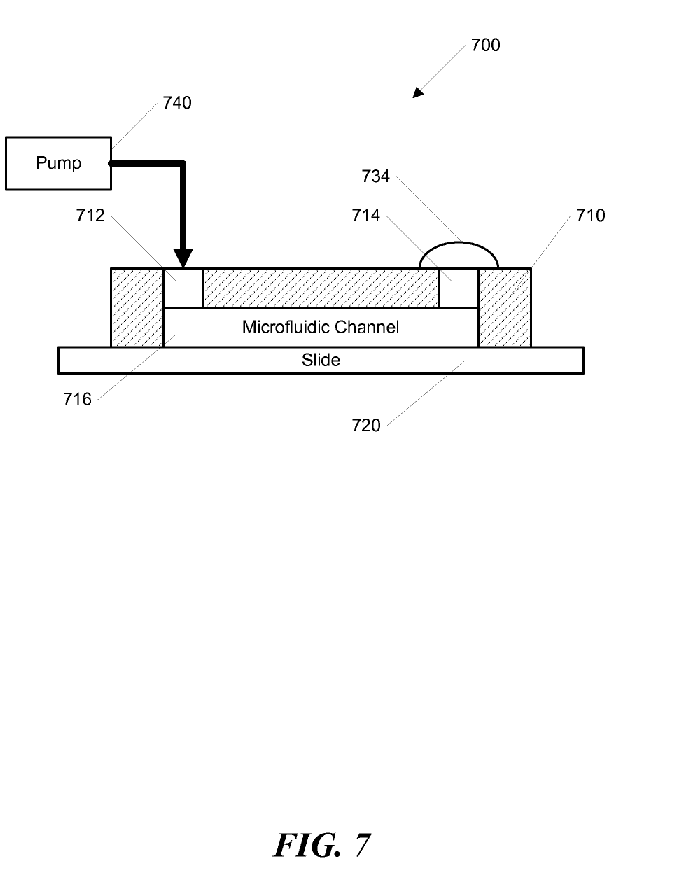

FIG. 7 shows a diagram of a microfluidic device 700 according to an embodiment of the invention. The microfluidic device 700 includes a top portion 710 into which the microfluidic channel 716 is formed. The top portion 710 can be bonded to a bottom portion 720. The microfluidic device 700 also includes an inlet port 712 connected to one end of the microfluidic channel 716 and an outlet port 714 connected to the other end of the microfluidic channel 716. The inlet port 712 is connected by tubing to a pump 740, such as a syringe pump, which can inject and withdraw a predefined amount of the gradient material solution to the inlet port 712. In preparation of the concentration gradient, the channel can be filled with a buffered solution and optionally, a large drop 734 of the buffered solution can be placed on the outlet port 714. After the large drop 734 of buffered solution is placed on the outlet port 714, the pump 740 is operated or programmed to inject a predefined volume of the gradient material solution at a predefined flow rate into the inlet port 712, to induce a forward flow rate in the channel for a predefined time. According to one embodiment of the invention, the pump 740 is stopped for a predefined period of time to allow the diffusion to mix the solution vertically. After the predefined delay, the pump 740 is operated or programmed to withdraw a predefined volume of the gradient material solution at a predefined flow rate from the inlet port 712 to stretch the concentration gradient. The cycle comprising a forward flow, a delay and a backward flow can be repeated (with an optional delay in between) until the concentration gradient grows to fill the channel. After the last backward flow and an optional delay, an optional forward flow can be induced in the channel to increase the length of the gradient. The inlet port and optionally, the outlet port can be sealed to stop the growth and stabilize the concentration gradient.

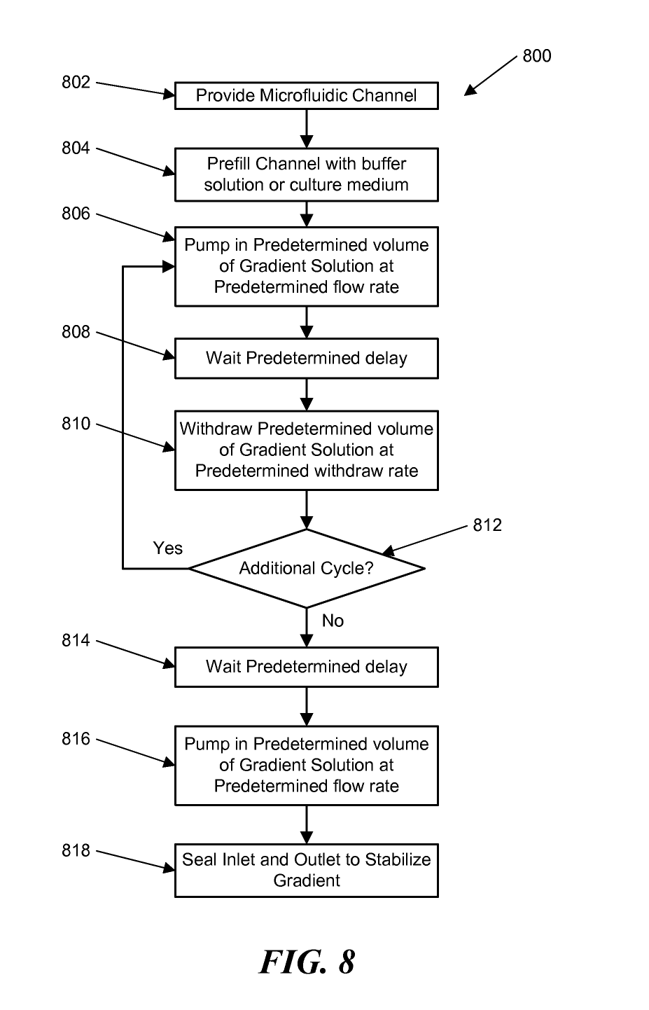

FIG. 8 shows a flow chart of the process of generating the concentration gradient in the microfluidic channel 716 according to an alternative embodiment of the invention. In accordance with the invention, the microfluidic channel 716, having an inlet port 712 and an outlet port 714, in which the concentration gradient is to be created, is provided at 802. The microfluidic channel 716 can be part of a microfluidic device 700 such as shown in FIG. 7. The microfluidic channel 716 is prefilled with a non-viscous solution, such as a buffer solution or culture medium, at 804. At 806, a large drop 734 of the non-viscous solution is optionally placed on the outlet port 714 and the pump 740 is operated or its program initiated to inject a predefined volume of gradient material solution into the inlet port 712 to cause a forward flow of the gradient material in the channel 716, from the inlet port to the outlet port. After the predefined volume of gradient material solution is injected into the inlet port 713, the pump 740 is stopped for a predetermined delay period to allow for diffusion, at 808. At the expiration of the delay period, the pump 740 is reversed (either manually operated or as part of a program) to withdraw a predetermined amount of gradient material solution at a predetermined flow rate, to cause a backward flow of the gradient material in the channel toward the inlet port 712, at 810. Depending on the desired length of the concentration gradient, cycle of forward flow, delay and backward flow, can be repeated using the same or different flow parameters (volume, flow rate and time delay) at 812 to grow the concentration gradient to the desired length. After the last backward flow (for example, 810), an optional delay (for example, 814) and, at 816, an optional forward flow can be caused by pumping a predetermined amount of gradient solution into the channel 716 to further stretch the concentration gradient. After the concentration gradient reaches the desired length, the inlet port and, optionally, the outlet port can be sealed (such as with oil or 100% humidity), at 818 to stabilize the concentration gradient in the channel 716.

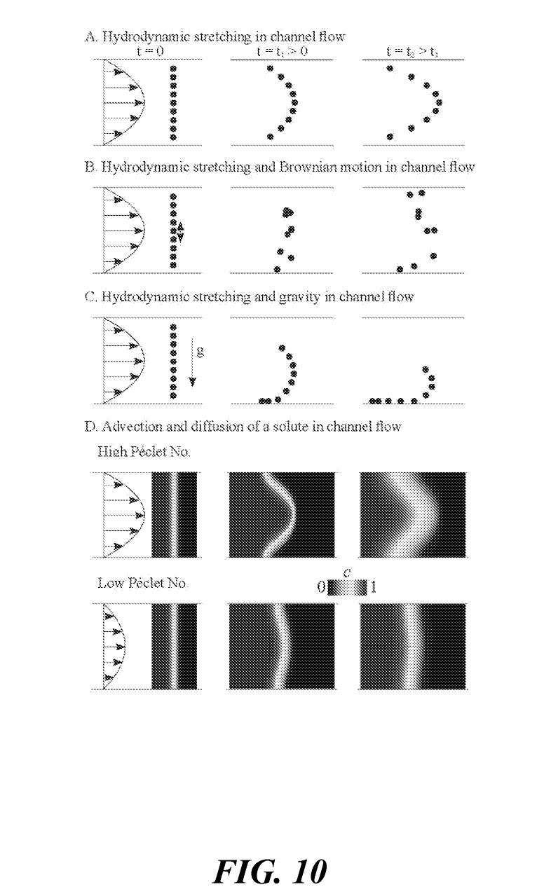

FIG. 10 shows a schematic for gradient generation and modes of spreading in channel flow. FIG. 10A shows particles spreading due to hydrodynamic stretching. FIG. 10B shows how diffusion suppresses longitudinal spreading. FIG. 10C shows the effect of gravity on gradient material. FIG. 10D shows advection and diffusion of solute dissolved in the flow, for high Péclet number (high flow rate or small diffusivity) and low Péclet number (low flow rate or high diffusivity).

In accordance with this embodiment, fluidic shear-driven stretching, also known as hydrodynamic stretching, is the primary mode of gradient generation. A particle in the center of the channel moves faster than one at the wall and the two spread apart at a rate proportional to the maximum channel velocity. As shown in FIG. 10A, a gradient forms in the laterally averaged concentration profile. Diffusion acts to suppress hydrodynamic stretching by reducing the mean variation in particle speeds slowly moving particles near the wall diffuse toward the centre and accelerate, while fast moving particles near the center diffuse toward the wall and decelerate as shown in FIG. 10B. For dilute suspensions of micron sized and larger particles moving in viscous flows, diffusion is negligible. However, as shown in FIG. 10C, negatively buoyant particles settle under gravity to the channel bottom, whereupon all particles experience the same low velocity and spreading ceases. Thus, high flow rates improve stretching at all scales: for molecules, high flow rates dominate diffusion which acts to suppress hydrodynamic stretching; for microparticles such as microbeads and cells, high flow rates are useful to spread the particles before they settle. In accordance with the invention, high-speed (mm/s) flow shear-driven stretching can be used to generate gradients of a wide range of gradient materials (e.g. molecules, cells and microbeads) along a simple microchannel.

The spreading of gradient material in a microfluidic channel involves both hydrodynamic stretching (advection) and diffusion, a combined process known as dispersion as shown in FIG. 10D. The Péclet number Pe=UH/D specifies the ratio of the rates of transport by flow advection at speed U and molecular diffusion D in a channel of height H and ranges from approximately 400 to 4000 in our experiments. In the axial direction, transport is mainly due to advection; in the transverse direction, transport is due to molecular diffusion since the flow velocity is purely axial. A typical flow sequence to spread a diffusible species in a microchannel is illustrated in Appendix B, FIG. 1C and proceeded as follows. The transported species was introduced into one end of the channel and the flow began. The concentration profile was hydrodynamically stretched and the initially short, steep gradient in concentration spread (Appendix B, FIG. 1Ci). The profile stretching was suppressed by lateral molecular diffusion, so that larger spreading was observed for larger Péclet numbers. The flow was stopped before the gradient reached the end of the channel. At this point, as we explain shortly, it was advantageous to keep the fluid at rest for an order H²/(π²D) time (in our case ˜5-30 s) to allow diffusion to completely mix the solution vertically (Appendix B, FIG. 1C ii). The flow was then reversed and stopped before the gradient reached the opposite end of the channel (Appendix B, FIG. 1C iii). The cycle was repeated until a gradient of sufficient length was obtained. As the gradient grew and filled the channel, the flow segments became shorter. These short duration flows laterally smoothed the concentration profile by shortening the spatial lags between the wall and centreline concentration profiles.

In a channel of uniform cross-section characterized by a height scale H and width scale W, where we assume without loss of generality that H≦W, three different regimes of dispersion exist: a short time regime t<<H²/D where diffusion is not important, molecules follow the streamlines, and gradient growth is linear; an intermediate time interval H²/D<<t<<W²/D over which the molecules spread over the channel height; and a long time regime t>> [symbol] W²/D, called Taylor-Aris dispersion, over which molecules have sampled the entire channel cross-section. In one example, the channels are rectangular with a height H=100 μm and width W=2 mm, with molecules of diffusivity D ˜10⁻⁷ to 10⁻⁶ cm² s⁻¹. Thus H²/D is seconds to minutes and W²/D is hours to days. Since the concentration gradients are generated in seconds to minutes, their evolution falls in the early to intermediate dispersion regime. Approximate theoretical descriptions valid for early, intermediate, and late times exist for many geometries, including rectangular channels, cylindrical tubes, and channels with smooth cross-sections. In these approximate theories, the cross-sectionally averaged concentration has the classic erfc profile (Appendix B, II.3c) with a dispersivity \tilde{D}, which plays the role of an effective diffusivity, though orders of magnitude larger than the molecular diffusivity. The theories listed above give different forms for the dispersivity depending on the time regime and the geometry. All theories listed are for uni-directional flow; the effects of flow reversal can be computed numerically.

To rationalize the experimental findings and to provide general experimental design criteria, a computational model was developed for the advection and diffusion of a diffusible species in sequences of forward and backward flow segments across a wide range of channel geometries and Pe'clet numbers (Appendix B, II.3d). Dimensional analysis reduces the parameter space to four dimensionless parameters: W/H, Pe, Re, L/H (Appendix B, II.1). In accordance with the invention, the Reynolds number Re=UH/v which quantifies the relative magnitudes of fluid inertia and viscosity, is 0.1 or less. Thus, throughout the rectangular channel the flow is essentially fully developed laminar Poiseuille flow, a textbook exact solution to the Navier-Stokes equations governing the fluid flow (Appendix B, FIG. 5 and Supp. II.2). For this exact flow solution, which is independent of the axial coordinate x, the convective derivatives in the Navier-Stokes equation vanish and hence so does the dependence on the Reynolds number. Since the flow velocity does not depend on the axial coordinate x, the effect of the channel length is merely to provide a stopping point once the gradient reaches the end of the channel. Thus, our computation model for the gradient evolution is characterized by only two parameters, W/H and Pe. Using the exact flow solution and for a wide range of parameter values, W/H=1 to 20 and Pe=100 to 10⁴, a finite element code (Comsat AB) can be determined to solve the advection-diffusion equation in the microchannel on a rectangular grid (Supp. FIG. 2). In cases where the flow is off, molecular species spread via pure diffusion over the diffusive timescale τ=tD/H², which has an analytical expression in the rectangular channel and may be readily calculated using discrete Fourier transforms (Appendix B, II.3a). Flow reversal is modelled by initializing the computational model with the concentration profile following the previous flow segment or pure diffusion segment and running the steady flow backwards. Further details including computational code and a sensitivity analysis are provided in Appendix B, II.3d. The resulting numerically computed concentration profiles were cross-sectionally averaged and the gradient length Δ was extracted. In this example, the gradient length Δ is defined as the distance between 10% and 90% of the maximum concentration, which captures the most linear, and therefore usable, portion of the concentration profile.

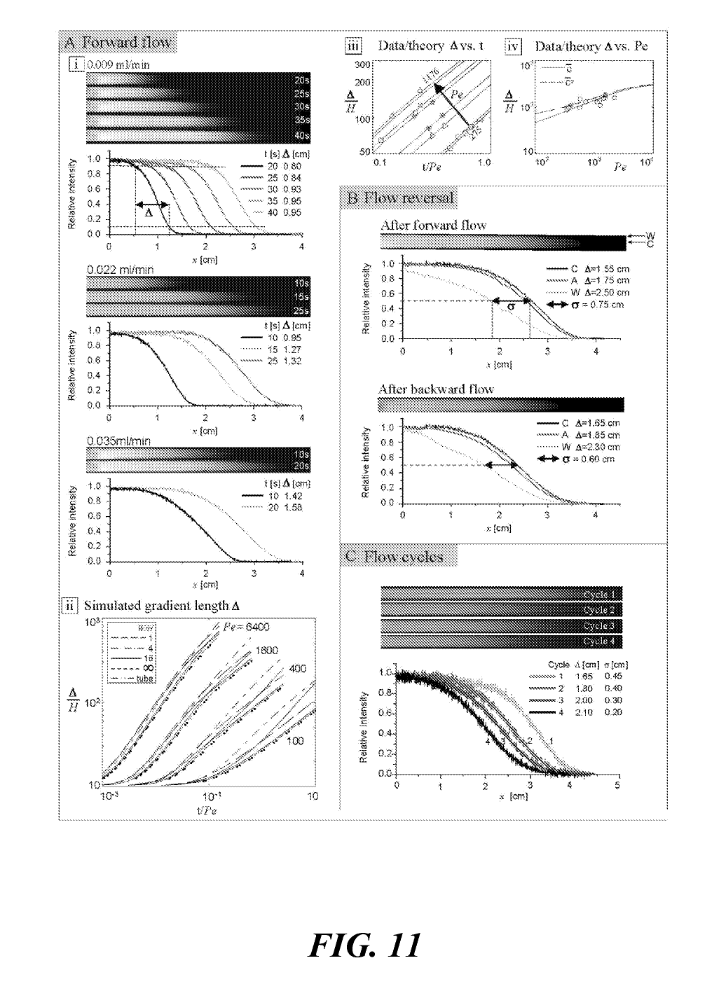

FIG. 11 shows the generation of long-range molecular gradients. FIG. 11A shows long range molecular gradient generation in uni-directional flow: i) top-down view of fluorescent FITC-Dextran gradient and quantification along channel centerline at flow rates Q=0.0092, 0.022, 0.035 ml/min; ii) simulation of gradient growth vs. time for various Péclet numbers Pe and channel aspect ratios W/H; iii) gradient growth vs. time for experiments (mean flow speeds U=2.5 (Δ), 1.9 (□), 1.7 (x), 1.1 (*), 0.95 ( [symbol] ), 0.62 (+), 0.58 (∘) mm/s from left to right) and corresponding simulations (W/H=20, Pe=1889, 1457, 1333, 884, 734, 476, 450 from left to right); iv) gradient length along centerline of channel after fluid travels x=2.34 cm for experiments (∘), simulation ( [symbol] vertically averaged centerline concentration, - - cross-sectionally averaged concentration), and fitting formula (-•-); FIG. 11B shows long range molecular gradient generation in backward flow: top-down view of fluorescent FITC-Dextran gradient and quantification of centerline (C), wall (W), cross-sectionally averaged (A) gradient profiles, gradient length Δ and spatial lag σ. FIG. 11C shows long range molecular gradient generation in alternating flow cycles: top-down view of fluorescent FITC-Dextran gradient and quantification along centerline, including gradient length Δ and spatial lag σ.

In order to facilitate rapid gradient growth, higher flow rates dominate diffusion to generate longer gradients, even if the total distance the fluid moves along the channel is kept constant. This was quantified experimentally by producing gradients of FITC-Dextran with different flow rates, and theoretically with numerical simulations. Fluorescent images of the microchannel were captured at 5 s intervals (FIG. 11A i). Consistent with the definition above, in this embodiment, the gradient length Δ is defined as the distance over which the fluorescent intensity profile is between 10% and 90% of its maximum. Quantification of the fluorescent images illustrates that gradients grow faster and longer with higher flow rates. Our numerical simulations of gradient length support this conclusion (FIG. 11A ii). Higher Péclet numbers are associated with faster gradient growth rates and longer gradients; the channel geometry has a secondary effect. The numerical predictions of gradient growth are in agreement with the experiments over a wide range of Pe (FIGS. 11A iii-iv). The measured intensities were taken from above and were therefore vertically averaged, by definition. The numerical results were vertically averaged for comparison. In FIG. 11A iii, the experimentally measured centreline gradient lengths compared well with predictions. To account for variable initial experimental gradient lengths (not controlled), the measurements were moved along the time axis so that the initial measurement coincided with the predicted gradient length profile. In FIG. 11A iv, the numerical predictions of the centreline gradient length after the fluid moves a fixed distance Ut=2.92 cm (simulation time t′=tU/H=234) also compare well with experimental data. In summary, the numerical, results support the experimental finding that gradients grow faster at higher flow rates, and grow longer even when the different flows are allowed to move the same net distance down the channel.

For diffusible gradient materials in a finite channel, additional gradient growth can be obtained by subsequence backward and forward flow segments (FIG. 11B). Since the rapid gradient growth is due to high-speed flow rate shear-driven stretching, it is important to consider how the concentration profile shape and concomitant gradient length change when the flow is reversed. In the absence of diffusion, flow reversal would undo the hydrodynamic stretching and collapse the gradient. The effect of flow reversal on the gradient length was predicted numerically by reversing the flow after different durations of diffusion downtime followed the forward flow segment (Appendix B, FIG. 3). If the flow is reversed immediately without any diffusion downtime, gradients shrink as the hydrodynamic stretching of the previous flow segment is partially undone. With even brief diffusion downtimes, in particular those long enough to allow for vertical mixing, (t=0.1H²/D≈H²/(Dπ²) or π=0.1), the gradient shrinking is virtually eliminated for most channel cross-sections. The flow sequences used in the experiments involved multiple forward-backward flow cycles with 30 s diffusion downtimes between flow segments to allow for vertical mixing and to eliminate gradient shrinking. After four cycles (four forward segments and three backward segments), a 3 cm FITC gradient was obtained that was nearly laterally uniform (FIG. 11C).

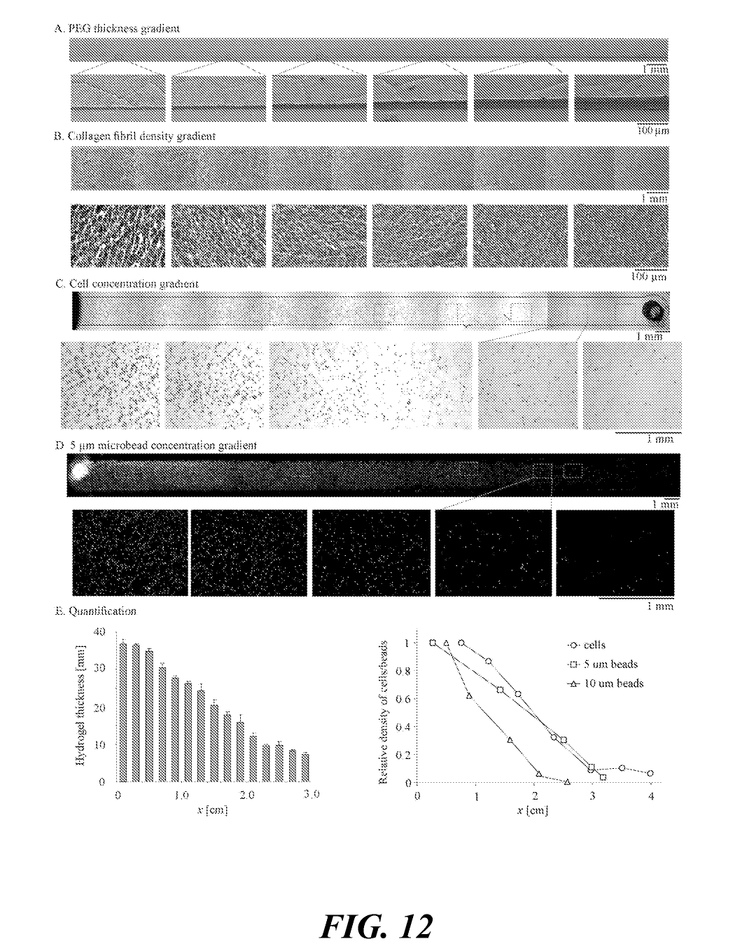

FIG. 12 shows the generation of long-range gradient of particles, cells and materials. FIG. 12A shows an SEM image (with low and high magnification) of PEG-DA hydrogel gradient. FIGS. 12B and C show an image of fluorescent particles (diameter 5 μm) and endothelial cells, respectively. FIG. 12D shows the quantification of the continuous variance in thickness of the hydrogel gradient. FIG. 12E shows the quantification of the relative density profiles of endothelial cells and fluorescent particles (with diameters of 5, 10 μm).

By combining material engineering technologies, the high-speed gradient generation method according to the invention was used to create material gradients of synthetic and natural polymers with controlled property variations. In each example, a concentration gradient of precursor solution of a material was first generated in accordance with one embodiment of the invention and then polymerized by the appropriate cross-linking method. FIG. 12A shows SEM images of the air-dried PEG-DA hydrogel gradient with a continuous variance in thickness. The concentration gradient of PEG-DA precursor solution was photopolymerized to form the hydrogel gradient. As quantified in FIG. 12E, the thickness of the dried hydrogel gradient gradually increased from ˜10 μm in the region formed with 5 wt % PEG-DA to ˜40 μm in the region with 40 wt % PEG-DA. In another example, thermally cross-linked collagen gradients were produced and visualized after free-drying. The porous 3D collagen mesh exhibited continuous changes of fibril density (FIG. 12B).

The gradient platform according to the present invention can also be used to produce material gradients of various microparticles. Using high flow speeds (mm/s), gradients of endothelial cells and 5 μm and 10 μm microbeads were generated along the channel (FIG. 12 C-E). The ability to rapidly generate nano/micro particle gradients may be useful to establish a controlled release system to deliver drugs with spatial variations. The cell gradient with controlled variations in cell density is potentially useful for generating bio-mimetic tissue constructs with heterogeneous cellular density and distribution (e.g. cartilage tissue).

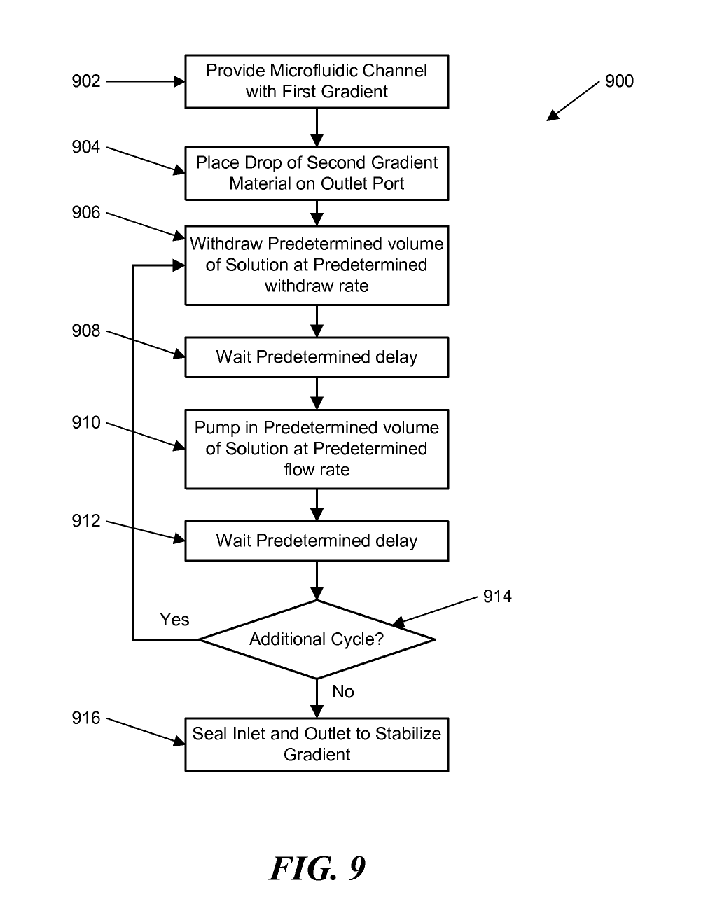

FIG. 9 shows a flow chart of the process of generating a cross-gradient in the microfluidic channel 716 according to an alternative embodiment of the invention. In accordance with the invention, the microfluidic channel 716, having an inlet port 712 and an outlet port 714, in which a first concentration gradient has been generated, is provided at 902. The microfluidic channel 716 can be part of a microfluidic device 700 such as shown in FIG. 7. The microfluidic channel 716 includes a first concentration gradient, preferably produced in accordance with the invention. At 904, a large drop 734 of the second gradient material solution is placed on the outlet port 714. At 906, the pump 740 is operated or its program initiated to withdraw a predefined volume of solution from the inlet port 712 to inject the second gradient material solution into the outlet port and to induce the second gradient material to flow backward in the channel 116, from the outlet port to the inlet port. After the predefined volume of solution is withdrawn from the inlet port 712, the pump 740 is stopped, optionally, for a predetermined delay period, at 908. At 910, the pump 740 is reversed (either manually operated or as part of a program) to inject a predetermined amount of the solution (for example, a mixture of the first gradient material and the second gradient material in solution) into the inlet port at a predetermined flow rate, to induce the second gradient material to flow forward in the channel toward the outlet port 714. After the predetermined volume of solution is injected into the inlet port 712, the pump 740 is stopped, optionally, for a predetermined delay period, at 912. Depending on the desired length of the concentration gradient, cycle of backward flow and forward flow, can be repeated using the same or different flow parameters (volume, flow rate and time delay) at 914 to grow the concentration gradient to the desired length. After the concentration gradient reaches the desired length, the inlet port and the outlet port can be sealed (such as with oil or 100% humidity), at 916 to stabilize the concentration gradient in the channel 716.

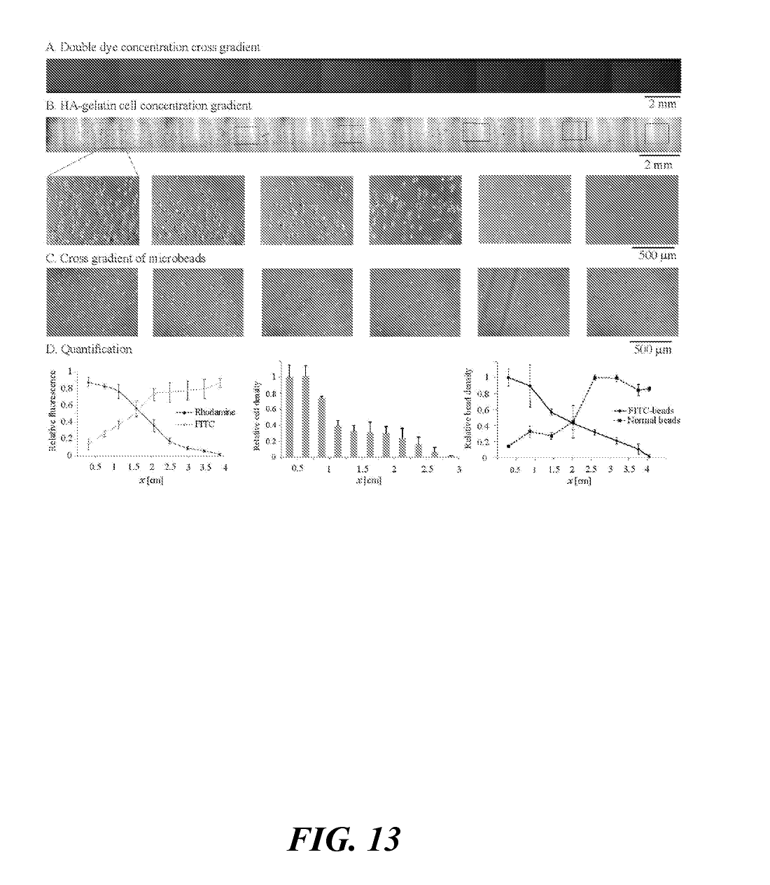

The gradient platform according to the present invention allows cross-gradients to be formed by loading one species in one port, creating a single gradient on the forward flow, loading a second species in the opposite port and reversing the flow to create crossing gradients. FIG. 13 shows the generation of a cross gradient of FITC-Dextran and Rhodamine Dextran. FIG. 13A shows the merged, fluorescence image of a cross gradient of FITC-Dextran (Green on right) and Rhodamine Dextran (Red on left). FIG. 13B shows the phase images (upper: lower magnification; lower: higher magnification) of SMC cultured on a substrate made from a composite material with HA-gelatin cross gradient. FIG. 13C shows the merged phase and fluorescence image of a cross gradient of 5 μm fluorescent microbeads and non-fluorescent microbeads. FIG. 13D shows the quantification of the relative fluorescence of the FITC-Dextran/Rhodamine Dextran cross-gradient and relative cell density on the composite materials with HA-gelatin cross-gradient.

In one example, this method was used with four flow cycles to generate a 2 cm cross-gradient of the fluorescent dyes FITC-Dextran (mw 10 KDa) and Rhodamine-Dextran (mw 10 KDa) (FIG. 13A). The cross gradient approach according to the invention can be used to generate composite materials that can be used as multi-functional biomaterials with optimal biological, mechanical, and therapeutic properties for tissue engineering applications. As an example, the cross-gradient method according to the invention can be used to create a composite material that regulates cell attachment. Hyaluronic acid (HA) and gelatin regulate cell behaviour differently. HA is cell repellent, while gelatin is bio-active. Crossing gradients of the precursor solutions of methacrylated HA and gelatin were first formed and polymerized by UV cross-linking. Smooth muscle cells (SMCs) were cultured on the resultant HA-gelatin composite hydrogel to investigate the effect of the composite cross-gradient material on cell adhesion. After 24 h of incubation, the majority of attached SMCs were found on the gelatin dominant region and the number of attached cells gradually decreased along the composite cross gradient material as the ratio of HA increased (FIG. 13B,C). In addition to a cross gradient of polymers, a cross gradient of two types of microbeads can also be generated in a similar manner. In one example, Microbeads were loaded into opposing ports on successive flow segments with downtime in between to allow the first type of microbeads to settle. After one flow cycle, the two types of microbeads were well mixed with each other in different ratios along the channel, as shown in FIG. 13C, D.

To facilitate the design of gradient devices, the following approximate formula can be used to estimate gradient length, Δ(t)/H=3.6\sqrt{\tilde{D}τ}, where τ=tD/H² is the dimensionless diffusive time and the dimensionless dispersivity is

$$\tilde{D} = 1 + \frac{{Pe}^{2} b}{210} ( 1 - \frac{1 - {e}^{- 4 a {π}^{2} τ}}{4 a {π}^{2} τ} ) \qquad ( 1 )$$

(see Supp. II.2c for details). The formula for D was originally found to be an excellent approximation for the dispersion between parallel plates, uniformly valid in time. An example of a table of the added fitting coefficients a and b is provided in Appendix C. For each W/H and Pe, values that best fit our numerical simulation of Δ(t) were chosen (Appendix B, FIG. 4). The maximum error between the numerical simulations and formula (I) is 7% over times 0<tU/H<1000. For large W/H, a and b approach 1, the case of the 2D infinitely wide channel. For large Pe, the growth rate becomes more linear, since the quantity a τ is smaller. The numerical simulations are not sensitive to the grid resolution or the form of the initially smoothed step function (Appendix B, II.3d and Supp. FIGS. 6, 7). Lastly, Excel and Matlab lookup tables for a and b are provided in Appendix B. The gradient length formula can serve as a tool for channel and flow design. As an example, we note that after a time t, the center of the gradient has moved a distance Ut and the gradient length is Δ(t), so the position of the tip of the gradient can be determined by Ut+Δ(t)/2, assuming the initial step profile was centered at x=0. If the channel length is L and it is desired that the gradient be kept inside the channel, the flow duration must not exceed a time t* where Ut*+Δ(t*)/2=L. Note that since diffusion suppresses gradient growth, the maximum distance particles of any type can move down the channel is 1.5 Ut and hence Δ(t)≦Ut.

While hydrodynamic stretching creates long gradients in seconds, the gradients produced may not be perfectly laterally uniform. The lateral (cross-sectional) non-uniformity is quantified by the distance σ between the x-locations of concentration c=0.5 at the channel centre and at the wall. Appendix B, FIG. 8A shows the center, wall, and laterally averaged concentration profiles over the initial forward flow segment. The profiles are more spread apart (higher σ) for higher flow rates; channel cross-section has a secondary effect (Appendix B, FIG. 8c). Initially σ grows linearly but may later grow more slowly due to diffusion. Diffusion alone can render the concentration profiles uniform over the long timescale W²/D (Appendix B, FIG. 9). However, flow reversal combined with short diffusion downtimes offers a much faster approach. Appendix B, FIG. 8b shows the center, wall, and averaged concentration profiles corresponding to those in Appendix B, FIG. 8a, following 30 s of pure diffusion downtime and a reverse flow segment. Numerical simulations of the backward flow illustrate that the separation a decreases to 0 and then increases, as the hydrodynamic stretching of the previous flow segment is undone and then the profile is stretched in the opposite direction (Appendix B, FIG. 8d). If lateral uniformity is desired, the flow may be stopped when σ reaches zero. The longer the pure diffusion segments, the sooner σ reaches zero. However, since diffusion is relatively slow and the flows are relatively fast, lateral uniformity should be achieved primarily by the flow. As Appendix B, FIG. 1c iii illustrates, sufficient room must exist in the channel to move the gradient enough to reduce σ to zero. Thus depending on the application, an optimal flow sequence may involve a mix of flow segments devoted to growing the gradient and those devoted to improving lateral uniformity. Note that for non-diffusible species, flow reversal will merely undo the hydrodynamic stretching and collapse the gradient, unless the particles are negatively buoyant and have settled, in which case flow reversal has no effect.

In accordance with the invention, the channel size can affect the time required to generate a gradient of a given length Δ. In the absence of diffusion, the gradient length evolves as 1.2Ut, given above, which is independent of the channel dimensions provided the average flow speed U is kept constant. Generating a gradient of length Δ requires Δ/1.2U time. For non-diffusible species, a uniform gradient is formed once the particles settle to the channel bottom, and hence the settling time scales as the channel height. For diffusible species, increasing the smallest dimension of the channel, defined here as the height H, while keeping U constant increases the Péclet number and enhances hydrodynamic stretching. However, achieving a uniform gradient requires lateral diffusive mixing. While flow reversal may be used to render the gradient uniform across the largest lateral dimension of the channel, defined here as the width, to avoid collapsing the gradient diffusive mixing must first complete across the height, which requires a time H²/(π²D). Thus while scaling up may enhance the hydrodynamic stretching, the total time to generate a uniform gradient scales as the channel height H for non-diffusible species and as H² for diffusible species, where H is the smallest dimension of the channel.

For completeness, we comment on the effects of other parameters on gradient evolution. The Reynolds number Re=UH/v and the scaled channel length L/H do not directly affect the concentration profile and gradient evolution. The analytic solution for the fully developed flow profile has the special property that the convective derivatives in the Navier-Stokes equation vanish and hence so does the dependence on the Reynolds number. Moreover, since the flow solution is independent of the longitudinal coordinate x, the role of the channel length is merely to provide a stopping point once the gradient reaches the end of the channel. Thus while the channel length L/H affects the choice of time sequence, it does not directly affect the concentration profile. Lastly, temperature affects gradient formation through its effect on the diffusion coefficient.

### Materials:

Poly(ethelyene glycol-diacrylate) with Molecular Weight 4000 is available from Monomer-Polymer & Dajac Labs. The photo-initiator (PI), 2-hydroxy-1-[4-(hydroxyethoxy)phenyl]-2-methyl-1-propanone (Irgacure D2959), is available from Ciba Geigy (Dover, N.J.). Polyethylene microtubing (I.D. 0.38 mm, O.D. 1.09 mm) is available from Intramedic Clay Adams (Becton Dickinson & Co, MD). Green Fluorescent FITC-microbead and non-fluorescent microbead solutions are available from Polysciences (Warrington, Pa.). Human Umbilical Vein Endothelial cells (HUVECs) and endothelial cell basal medium (EBM-2, Clonetics) supplemented with 0.5 mL vascular endothelial growth factor (VEGF), 0.2 ML hydrocortisone, 0.5 ML epidermal growth factor (rhEGF), 0.5 ML ascorbic acid, 2.0 ML r-human fibroblast growth factor-B (rhFGF-B), 0.5 ML heparin, 0.5 ML recomb long R insulin-like growth factor (R3-IGF-1) and 0.5 ML gentamicin sulfate amphotericin-B (GA-1000) are available from Lanza (Basel, Switzerland). All other reagents are available from Sigma-Aldrich (St. Louis, Mo.) unless specifically mentioned.

In accordance with one embodiment of the invention, the microfluidic device includes a microchannel was fabricated by standard soft lithography methods as described above. It includes a top Polydimethylsiloxane (PDMS) fluidic channel that was plasma bonded to a bottom glass slide. Preferably, the rectangular channel dimensions were 100 μm (height)×2 mm (width)×50 mm (length), although other channel dimensions can be used.

### Generation of Biomolecule Gradient.

In accordance with one embodiment of the invention, the microchannel was pre-filled with 1× Dulbecco's Phosphate Buffered Saline (DPBS) solution. 1% wt fluorescein isothiocyanate-dextran (FITC-dextran) solution was introduced into the channel in one or more a cycle. Each cycle can include a forward flow, a delay, and a backward flow pumping sequence, for example: 4.67 μl of the solution was pumped in (inducing forward flow) at 0.009 ml/min flow rate, wait 30 s of down time, and 2 μl of the solution was withdrawn (inducing backward flow) at 0.022 ml/min flow rate. The cycle can be repeated as needed to increase the length of the concentration gradient, however, for this example, it was not needed. After the last cycle, there was a wait of 30 s for down time, and 1.34 μl of the solution was pumped in (inducing forward flow) at 0.035 ml/min flow rate. The solution was pumped in and withdrawn using a syringe pump (World Precision Instruments Aladdin 1000, WPI, FL) and the flow rates were calibrated with a flow meter (from Gilmont Instrument, IL). The inlet and outlet ports can then be covered with oil or exposed to a 100% humidity environment to preserve the concentration gradient.

### Generation of Bead/Cell Gradient.

In accordance with one embodiment of the invention, microbead stock solutions containing microbeads with diameters in 5.0 and 9.91 μm (with a solid fraction of 0.1% w/w) were diluted 10 times in DPBS. The microfluidic device was the same as described above, a PDMS top portion bonded to a glass slide bottom portion. A syringe pump and flow meter were used to pump and withdraw the gradient material solution and measure the flow rates. In this embodiment, 6 μL of the microbead solution was pumped into the channel at a rate of 0.035 ml/min, followed by a 30 s downtime before 4 μL of the solution was withdrawn back into the tubing. 4 μL of the fluid was pumped, then withdrawn, and finally pumped again into the channel with a 30 s downtime between flow cycles.

In an alternative embodiment of the invention, HUVECs were cultured in endothelial cell basal medium at 37° C. in a humidified incubator. The protocol for generating cell gradients was similar to microbead gradients. The HUVEC medium was used in place of DPBS as the background solution and a medium containing HUVECs (5×10⁶/ml) after trypsinization was used as the gradient material.

### Generation of Hydrogel Gradient.

In accordance with one embodiment of the present invention, a concentration gradient of hydrogel precursor solution (with high concentration of 40 wt % PEG-DA in DPBS and 1% PI) was first generated at 0.022 ml/min using the above-mentioned flow sequences for FITC-Dextran. To ensure the integrity of gradient in the hydrogel, 5 wt % PEG-DA solutions were pre-filled in the channel. Upon photo-polymerization (UV exposure: 10 mW/cm² for 20 s), the hydrogel precursor concentration gradient was cross-linked. For characterization, the resultant hydrogel was air-dried, cut with a scalpel blade to obtain a cross section, sputter-coated with gold and imaged using SEM (ULTRA 55, ZEISS). The thickness of the hydrogel was quantified relatively to the scale bar in the SEM image using ImageJ.

### Generation of Collagen Gradient.

In accordance with one embodiment of the present invention, the flow condition for generating PEG-DA hydrogel gradient was used to generate collagen concentration gradient (from 0.5 mg/ml to 3.8 mg/ml). Collagen fibers were formed upon gelation for 30 min in the incubator (37 C). The device containing the collagen gradient was then pre-frozen at −20 C for 10 min and demoulded, exposing the collagen gradient. The collagen gradient was further frozen at −80 C for 2 hr and then freeze-dried in a lyophilizer. The morphology of the collagen gradient was visualized by SEM.

### Generation of Cross-Gradient

In accordance with one embodiment of the present invention, a concentration gradient was generated from a solution containing 1 wt % FITC dextran (MW: 10 KDa) gradient material as described above. In accordance with the invention, the second gradient material, Rhodamine-Dextran (MW: 10 KDa) is introduced at the outlet port by withdrawing a predefined quantity of solution from the inlet port. In this embodiment, 200 μL Rhodamine-Dextran (MW: 10 KDa) solution (1 wt %) was pipetted onto the outlet port of the channel and 6 μL Rhodamine-Dextran solution was withdrawn into the channel from the outlet at a flow rate of 0.022 ml/min with a syringe pump which was connected to the inlet of the channel. The solution (6 μL) withdrawn into the tube was pumped back into the channel substantially immediately. This cycle of backward and forward flow induced by the pumping process was conducted for three times. The channel containing the cross-gradient of the double dyes was stabilized at least 30 s before visualization. A series of continuous fluorescent images along the channel were taken using the green filter and red filter of the fluorescent microscope respectively and then were stitched together using Photoshop. The merged double dye cross-gradient was further quantified using ImageJ. To create the cross gradient of microbeads, 5 μm diameter FITC-microbeads and non-fluorescent beads were diluted 20 times. The similar protocol as for creating FITC-dextran/Rhodamine-Dextran was followed except that a higher flow rate of 0.035 ml/min was used and only one flow cycle was conducted.

Generation of Composite Materials with Cross-Gradient of HA and Gelatine.

In one embodiment of the present invention, Hyaluronic acid and gelatin were methacrylated to be photo-crosslinkable as described previously. 2 wt % methacrylated HA solution (containing 1 wt % PI) was pre-filled into the channel and 2 wt % methacrylated gelatin (1 wt % PI) was added onto the outlet of the channel. HA and gelatin cross gradient was formed as mentioned above for FITC-dextran/Rhodamine-Dextran cross-gradient and stabilized upon photo-polymerization (UV exposure: 10 mW/cm² for 60 s). Smooth muscle cells (SMC) were cultured in SMC basal medium (RPIM 1640, Gibco) at 37° C. in a humidified incubator. Upon trypsinization, the cells were seeded in a density of 1×10⁴ cells/cm² on the surface of HA-gelatin composite hydrogels. After 24 h of incubation, the hydrogels were rinsed with sterile PBS for three times to wash away unattached cells and then fixed with 3.7% formaldehyde solution. A series of continuous phase contrast images along the channel were taken using microscope and then were stitched together. Cells were quantified by counting attached cell number using ImageJ.

In accordance with the invention, the pump can be controlled by a controller, such as a computer, and the flow cycles can be programmed such that the flow cycles are completed automatically. Other types of pumps can be used.

Other embodiments are within the scope and spirit of the invention. Features implementing functions may also be physically located at various positions, including being distributed such that portions of functions are implemented at different physical locations.

Further, while the description above refers to the invention, the description may include more than one invention.

1. A method of creating a concentration gradient in a microfluidic device, the device comprising a microfluidic channel formed in a substrate material connecting an inlet port and an outlet port, the method comprising:
filling the microfluidic channel with a non-viscous solution;
inputting into the inlet port, a predefined amount of gradient material solution, and causing a passive pump-driven forward flow in the microfluidic channel; and
evaporating the gradient material solution from the inlet port and causing an evaporation-driven backward flow; and
sealing the inlet port.

2. The method according to claim 1 wherein applying a predefined amount of the gradient material solution includes applying one or more drops of the gradient material solution to the inlet port.

3. The method according to claim 1 wherein evaporating the gradient material solution includes allowing the gradient material solution to evaporate from the inlet port.

4. The method according to claim 1 wherein evaporating the gradient material solution includes reducing the pressure in an area adjacent to the inlet port.

5. The method according to claim 1 wherein evaporating the gradient material solution includes increasing the temperature in an area adjacent to the inlet port.

6. The method according to claim 1 wherein the non-viscous solution is a buffered solution.

7. The method according to claim 1 further comprising applying a predefined amount of non-viscous solution to the outlet port prior to inputting a predefined amount of gradient material solution to the inlet port, whereby a large drop of non-viscous solution forms over the outlet port.

8. The method according to claim 1 wherein the gradient material solution includes gradient material selected from the group including diffusible molecules, biologic molecules, polymers, beads, particles and cells.

9. The method according to claim 1 wherein evaporating the gradient material from the inlet port is allowed to occur for at least 20 minutes before sealing the inlet port.

10. A microfluidic device comprising a concentration gradient formed from a concentration gradient material according the method of claim 1.

11. A method of creating a concentration gradient in a microfluidic device, the device comprising a microfluidic channel formed in a substrate material connecting an inlet port and an outlet port, the method comprising:
filling the microfluidic channel with a non-viscous solution;
injecting a gradient material solution into the inlet port according to at least one alternating flow cycle, the flow cycle comprising:
pumping a predefined amount of gradient material solution into the inlet port at a first predefined flow rate and causing a forward flow of the gradient material solution in the microfluidic channel;
waiting a predefined delay;
withdrawing a predefined amount of the gradient material solution from the inlet port at a first predefined withdrawal flow rate and causing a backward flow of the gradient material solution in the microfluidic channel; and
sealing the inlet port.

12. The method according to claim 11 further comprising, prior to sealing the inlet port,
waiting a predefined delay; and
pumping a predefined amount of gradient material solution into the inlet port at a first predefined flow rate and causing a forward flow of the gradient material solution in the microfluidic channel.

13. The method according to claim 11 comprising a second flow cycle prior to sealing the inlet port, the second flow cycle comprising:
pumping a second predefined amount of gradient material solution into the inlet port at a second predefined flow rate and causing a forward flow of the gradient material solution in the microfluidic channel;
waiting a predefined delay; and
withdrawing a second predefined amount of the gradient material solution from the inlet port at a second predefined withdrawal flow rate and causing a backward flow of the gradient material solution in the microfluidic channel.

14. The method according to claim 13 comprising a third flow cycle prior to sealing the inlet port, the third flow cycle comprising:
pumping a third predefined amount of gradient material solution into the inlet port at a third predefined flow rate and causing a forward flow of the gradient material solution in the microfluidic channel;
waiting a predefined delay; and
withdrawing a third predefined amount of the gradient material solution from the inlet port at a third predefined withdrawal flow rate and causing a backward flow of the gradient material solution in the microfluidic channel.

15. The method according to claim 11 further comprising applying a predefined amount of non-viscous solution to the outlet port prior to injecting a predefined amount of gradient material solution to the inlet port according to the at least one flow cycle, whereby a large drop of non-viscous solution forms over the outlet port.

16. The method according to claim 11 wherein the microfluidic device includes a top portion and a bottom portion and the method further comprises applying ultraviolet light energy to the gradient material to solidify the gradient material in the microfluidic device and removing the top portion of the microfluidic device to expose the solidified gradient material.

17. The method according to claim 11 wherein the microfluidic device includes a top portion and a bottom portion and the method further comprises freezing the gradient material to solidify the gradient material in the microfluidic device and removing the top portion of the microfluidic device to expose the solidified gradient material.

18. The method according to claim 11 wherein the length of the concentration gradient is determined as a function of a flow speed at which the gradient material flows is induced to flow in the microfluidic channel and an amount of time the gradient material is allowed to flow at the flow speed.

19. A microfluidic device comprising a concentration gradient formed of a gradient material according to the method of claim 11.

20. A method of creating a cross-concentration gradient in a microfluidic device, the device comprising a microfluidic channel formed in a substrate material connecting an inlet port and an outlet port, the method comprising:
providing a microfluidic device having a concentration gradient of a first gradient material in the microfluidic channel;
applying a predefined amount of a second gradient material solution to the outlet port, whereby a large drop of the second gradient material solution forms over the outlet port;
withdrawing a predefined amount of solution from the inlet port at a predefined withdrawal flow rate and causing the second gradient material solution to enter the outlet port and causing a backward flow of the second gradient material solution from the outlet port to the inlet port in the microfluidic channel; and
pumping a predefined amount of solution into the inlet port at a predefined flow rate and causing a forward flow of the second gradient material solution from the inlet port to the outlet port in the microfluidic channel.

21. A microfluidic device comprising a cross-concentration gradient formed of a first gradient material and a second gradient material according to the method of claim 20.
